(19) United States
(12) Patent Application Publication
(10) Pub. No.: US 2013/0206542 A1
(43) Pub. Date: Aug. 15, 2013

(54) Money-Operated Machine Made From an Extruded Profile and Comprising a Secure Strongbox

(71) Applicant: Francois Menoud, Plan-les-Ouates (CH)

(72) Inventor: Francois Menoud, Plan-les-Ouates (CH)

(73) Assignee: IEM SA, Plan-les-Ouates (CH)

(21) Appl. No.: 13/703,653

(22) PCT Filed: Jul. 20, 2011
(86) PCT No.: PCT/EP2011/062422

§ 371 Date: Jan. 21, 2013

(30) Foreign Application Priority Data
Jul. 23, 2010 (FR) 10/03129
May 16, 2011 (CH) 823/11

(51) Int. Cl. G07F 9/10

(52) U.S. Cl. CPC G07F 9/10
USPC 194/350

(57) ABSTRACT

The invention relates to a money-operated machine, comprising a housing made from an extruded profile (1) and having a compartment that houses a money acceptor and a compartment that houses a money box in communication with the money acceptor. According to the invention, in order to protect the collected money, the money box is housed in a strongbox consisting of metal sheets (10, 11, 12, 13), which are fitted into each other by indentations (15, 16) cut out on an edge of the metal sheets, and is attached to the extruded profile (1) by the cut-out indentations (15, 16) being inserted into grooves or notches (3, 5) of the extruded profile (1) acting as slides.

### BACKGROUND OF THE INVENTION

1. Field of the Invention

The invention relates to money-operated machines located in outdoor areas prone to vandalism. The machines contain money coming from successive payments.

2. Description of the Related Art

A machine containing money and/or bank notes has a reinforced compartment capable of withstanding vandalism. Generally, two methods are used. One is to introduce a strongbox into the housing of the machine. Such an example is described in document WO 2008/152063. The other method is to strengthen the whole machine or just the area where the money is kept. Such an example is described in document FR 2,767,593. To design and to produce reinforcements or strongbox may turn to be complicated and expensive.

Document U.S. Pat. No. 5,435,644 discloses a money-operated machine comprising a housing made from an extruded profile of moulded aluminium and having a compartment housing a money acceptor and a compartment housing a money box communicating with the money acceptor. The aluminium profile results from basic profiles that are assembled by screwing, each of them extending as a wall along the entire length of the housing. The compartments have division plates arranged perpendicularly to the longitudinal direction of the profile and screwed into grooves extending longitudinally in the walls of the basic profiles.

### SUMMARY OF THE INVENTION

The aim of the invention is to design the money compartment of a money-operated machine so as to simplify the production of said compartment and to provide the machine with an increased resistance to vandalism.

To this end, the invention relates to a money-operated machine comprising a housing made from an extruded profile and having a compartment housing a money acceptor and a compartment housing a money box in communication with the money acceptor, characterized in that, in order to protect the money collected, the money box is housed in a strongbox consisting of metal sheets fitted into each other by indentations cut on an edge of the metal sheets and assembled to the extruded profile in such a way that the indentations are inserted into grooves or notches of the extruded profile acting as slides.

The contribution of the present invention resides in the fact that an extruded profile, which is an economically advantageous product suitable for obtaining a high level of aesthetics, is properly assembled with ordinary metal sheets to result in a money-operated machine housing that is of particular ease to assemble, offers, once assembled, a better resistance to vandalism in comparison with the resistance that could be obtained form said components if they were not provided with the characterizing indentations and grooves of the present invention but merely assembled by ordinary techniques such as screwing, bolting, welding ect. . . . and accommodates for large tolerances that are encountered in extruded profile production.

On the one hand, according to the present invention, an extruded profile provided at each angle with grooves or notches for the metal sheet indentations to slide therein is an easy to produce and economical product. On the other hand, metal sheets provided with crenellations to fit into each other are relatively easy to produce by ordinary cutting techniques such as laser technique or stamping and then it is also easy to slide them as a whole into the grooves of the extruded profile. As a result, this assembly accommodates for large tolerances that are encountered in extruded profile production, embodies a high quality design due to its extrusion process of making and provides for an economical strongbox which is very easy to build, plus the contribution of all the components listed above for obtaining of a strongbox with a high resistance to vandalism.

The present invention further extends to a device for controlling the opening of the access door of the money box, arranged to efficiently withstand attacks seeking to steal money.

### BRIEF DESCRIPTION OF THE DRAWINGS

The figures listed below show different embodiments of the invention.

FIG. 1 shows a cross-section of the extruded profile.

FIG. 2 shows metal sheets of the strongbox not yet fitted into each other, at the front, right side and on the top.

FIG. 3 shows front, rear, lateral and top metal sheets of the strongbox fitted into each other.

FIG. 4 shows the metal sheets fitted into each other during the assembly process with the extruded profile.

FIG. 5 shows the internal components of the money-operated machine through a transparent side view of the extruded profile, all secured to a concrete base.

FIG. 6 shows the outward view of the money-operated machine.

FIG. 7 is a cross section view showing the strongbox positioned in the extruded profile.

FIG. 8 is a cross section view showing the strongbox positioned in the extruded profile, wherein said profile is provided with notches according to a particular embodiment of the invention.

FIG. 9 shows a metal sheet of the strongbox provided with indentations according to a particular embodiment of the invention.

FIG. 10 shows the device for controlling the opening of the access door of the money box through a transparent side view of the extruded profile.

FIG. 11 shows details of the opening mechanism of the money box access door.

FIG. 12 shows the guillotine which locks the money box access door.

FIG. 13 shows the security cylinder used in case of blackout.

### DETAILED DESCRIPTION OF THE PREFERRED EMBODIMENT

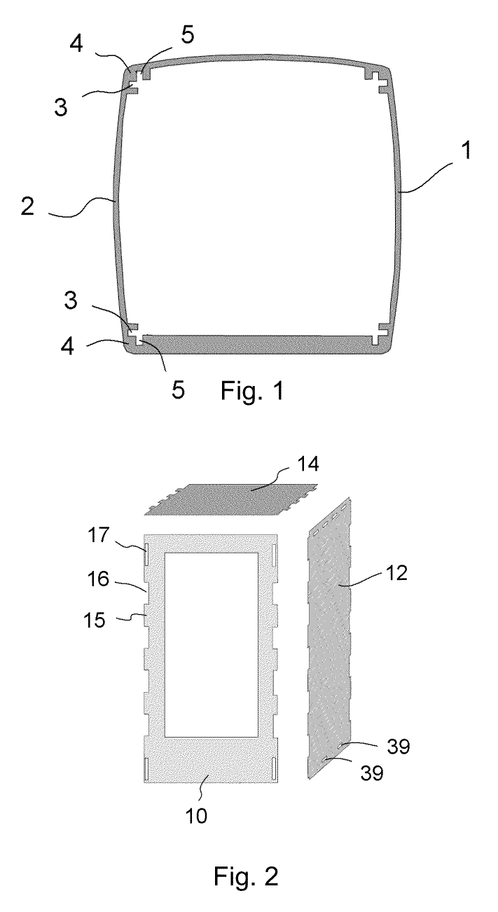

The invention involves an extruded profile, preferably of aluminium based alloy. FIG. 1, such a profile 1 includes in each of its corners, two perpendicular notches 3 and 5 which are formed by a thickness 4 of wall 2 of the extruded profile and extend over the entire length of the extruded profile for use as slides, as shown in FIG. 4.

FIG. 2 shows metal sheets of the strongbox not yet fitted into each other, at the front 10, right side 12 and on the top 14. The edges of the metal sheets are cut according to a crenellation pattern 15 and 16 to fit into each other once assembled. To facilitate the assembly process, some crenellations 17 may be bounded. Large tolerances, as high as several millimetres, may be encountered in extruded profile production, mainly due to exit temperatures of the extrusion press. Therefore, the metal sheet crenellations are dimensioned so as to accommodate such tolerances.

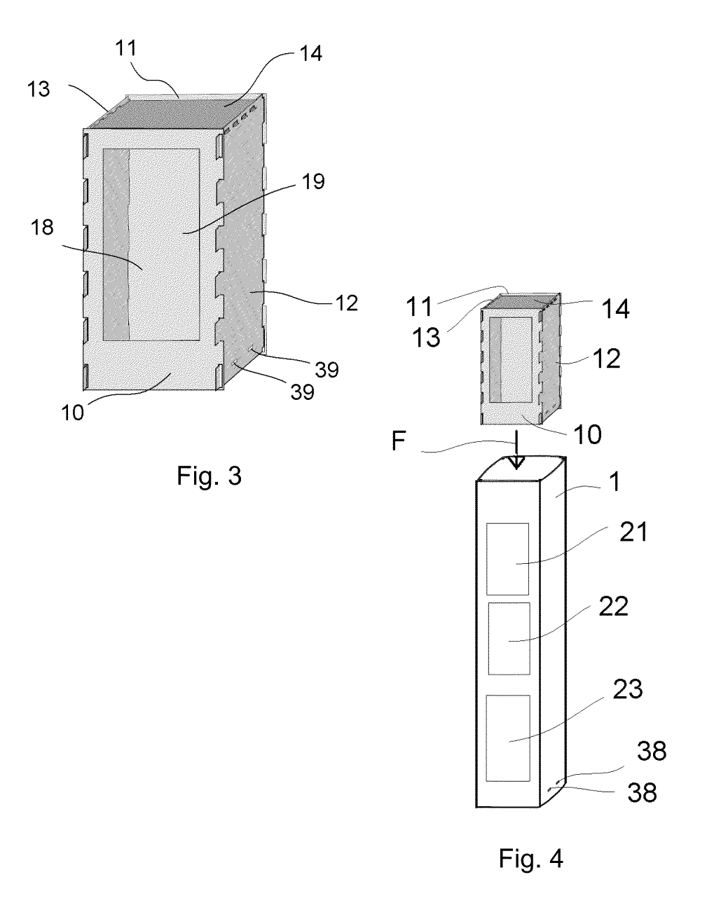

FIG. 3 shows front 10, rear 11, right 12, left 13 and top 14 metal sheets of the strongbox fitted into each other. The front metal sheet 10 is provided with an opening 18 necessitated by the access door of the strongbox.

FIG. 4 shows the metal sheets fitted into each other during the assembly process with the extruded profile 1. This operation can be done from the top, as indicated by arrow F. But it is also possible to do it from the bottom. Once the metal sheets are fitted into each other, the resulting crenellated edges of the strongbox are slid into notches 3 and 5 of the extruded profile 1.

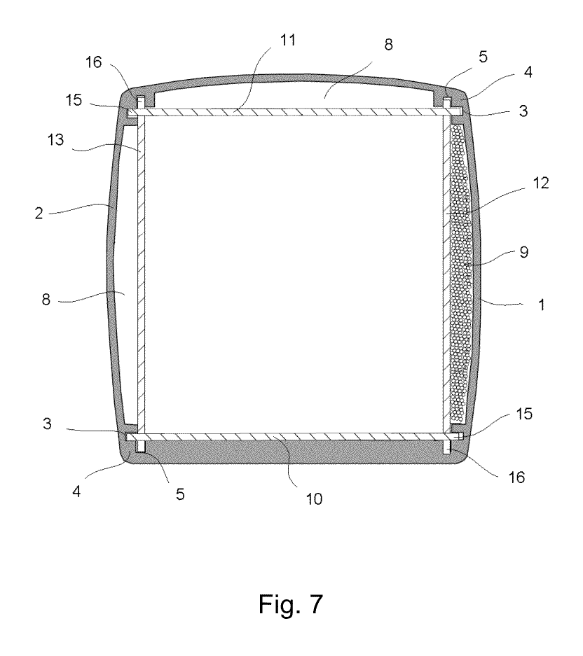

As it will be described in more details with reference to FIG. 7, the extruded profile 1 forms the housing of the money-operated machine. It comprises three openings 21, 22 and 23 respectively in connection with three compartments, the upper opening 21 with the money handling compartment, the intermediate opening 22 with the compartment that houses a printer and a roll of paper, and the bottom opening 23 with the compartment that houses a money box.

A simplified alternative execution is to use metal sheets provided with unbounded crenellations on one edge and bounded crenellations on the other edge. The unbounded crenellations of a metal sheet fit into the bounded crenellations of another metal sheet. Therefore, the extruded profile needs to be provided with only one notch per side.

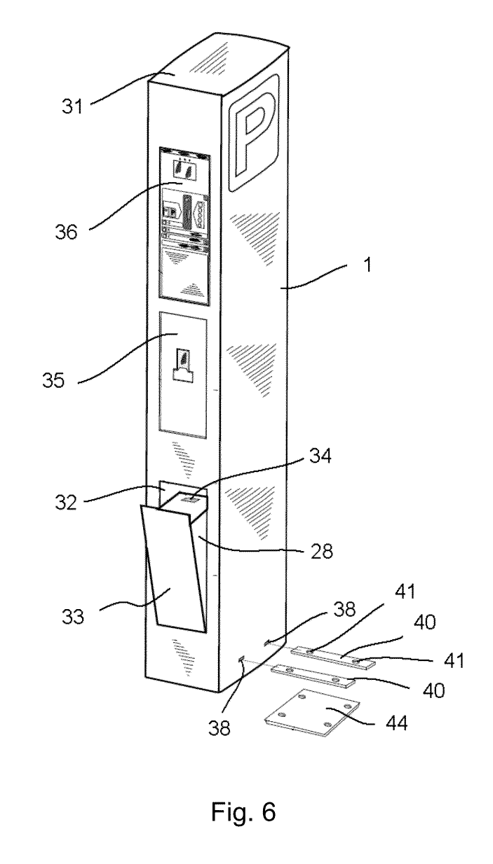

FIG. 2 shows the internal components of the money-operated machine through a transparent side view of the extruded profile, all secured to a concrete base 20. These components include: a money acceptor combined with a smart card reader 25, a ticket printer 26 coupled with a roll of paper for tickets 27, a money box 28 containing the money, a channel for money 29 drawn in dotted line, which enables a communication between the money acceptor 25 and the money box 28, the strongbox 19 and its metal sheets fitted into each other. As shown in FIG. 6, the strongbox 19 is slid level with the bottom opening 23 of the housing 1.

FIG. 6 shows the outward view of the money-operated machine which highlights the aesthetic rounded walls of the extruded profile 1. The top of the machine is provided with a glass ceiling 31 for the light to pass and supply a solar panel. The compartment 32 corresponding to the lower opening 23 of the housing, called “treasure” compartment, includes an access door 33 of the money box 28 and an inlet for the money to be inserted in the money box 34. The other compartments of the money-operated machine include compartment 35 corresponding to the intermediate opening 22, called printer and paper compartment, and compartment 36 corresponding to the upper opening 21, called money handling compartment.

On the bottom of the machine, wall 2 of the extruded profile 1 and side metal sheets 12 and 13 are provided with openings 38 and 39 for receiving two bars 40 extending through the extruded profile 1 and the strongbox 19. Each bar 40 has two openings 41 adapted to fixing rods 42 secured either to the concrete base 20 or to the ground. Said rods are provided with fixing bolts 43 at the end for securing the machine. A base plate 44 is arranged with the two bars 40 within the housing in order to hold them at the center of the housing and maintain the extruded profile 1 and the strongbox 19 secured to the concrete block 20. This effect is further enhanced by the fact that the access door 33 of the money box binds the extruded profile 1 and the strongbox 19.

FIG. 7 is a cross-sectional view showing the metal sheets fitted into each other in the strongbox 19 and how the crenellated edges 15 and 16 are inserted in the notches 3 and 5 of the extruded profile.

The aim of the present invention is the resistance to vandalism, mainly vandalism to steal the money of the machine. An attack with a grinder is difficult to resist. In this embodiment, FIG. 7, it is possible to fill the gap 8 left between the right, left and rear metal sheets 12, 13, 11 fitted into each other in the strongbox 19 and wall 2 of the extruded profile 1 with a material which causes the grinder disk to work badly or to get fouled up. This is achieved by means of sand that will melt under the effect of disk rotation or by means of balls or micro balls in polycarbonate or other materials having the same effect.

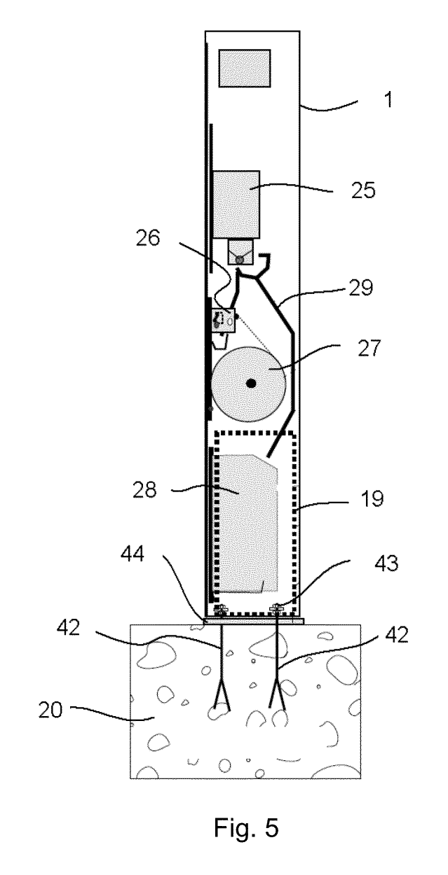

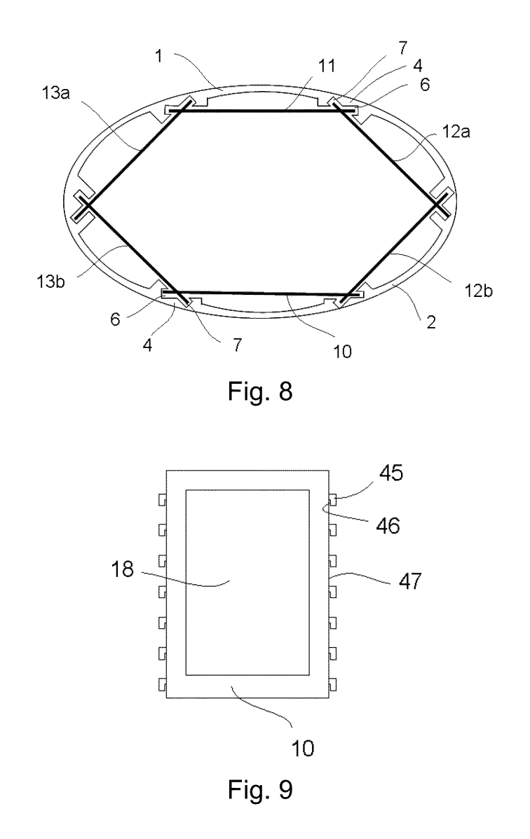

In the embodiment illustrated in FIGS. 1 to 7, the extruded profile has a quadrangular section and the notches are arranged at the four corners of the quadrangular section. However, the invention contemplates other sections of the extruded profile and other provisions of the notches in the wall thicknesses. For example, FIG. 8, the extruded profile 1 has an oval cross-section and notches 6 and 7 occupy the vertices of a hexagon and form between them, at each vertex, an acute, right or obtuse angle. The crenellated edges of metal sheets 10, 11, 12a, 12b, 13a, 13b fitted into each other in the strongbox of the money-operated machine are inserted into the notches 6 and 7.

Similarly, other forms of indentations are contemplated to fit the metal sheets into each other in the strongbox described in the embodiment illustrated in FIGS. 1 to 7. For example, FIG. 9, indentations 45 may be partially split at their base to have a slot 46 parallel to the edge 47 of the metal sheets so as to enable them to fit into each other by insertion of the slots into each other.

Another aspect of the present invention regarding resistance to vandalism is given by the opening mechanism of the so-called “treasure” compartment.

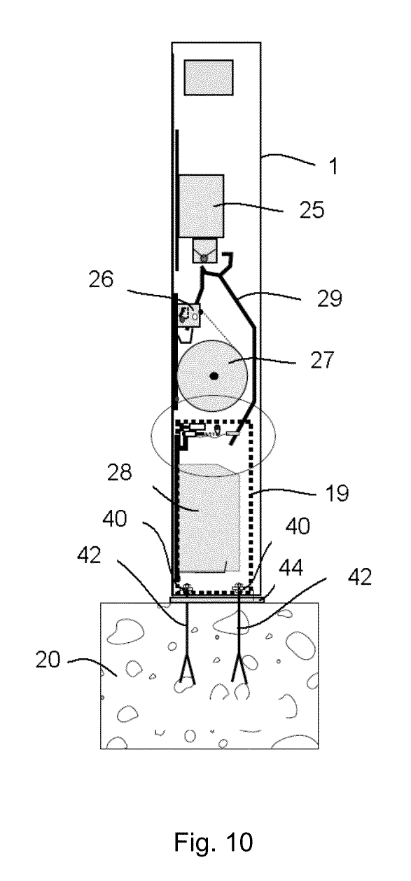

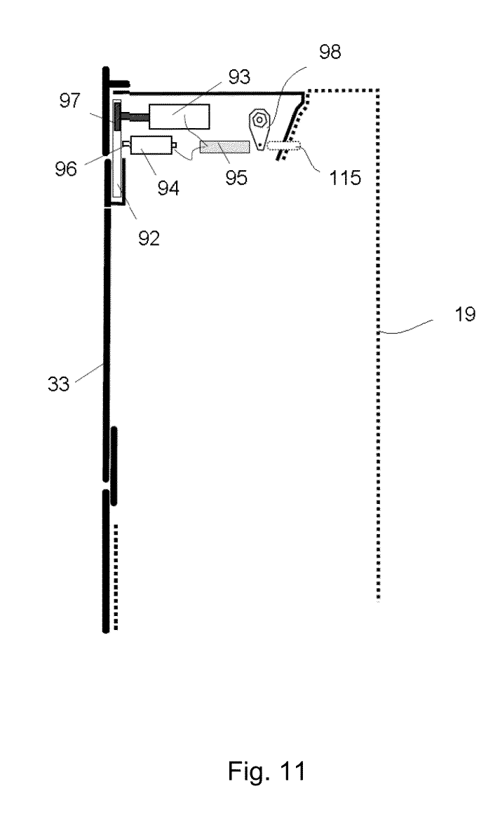

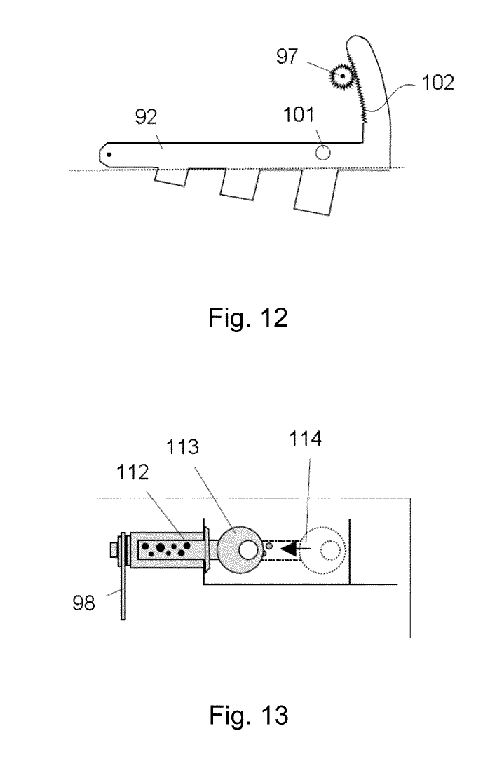

FIGS. 10 to 13, the opening of the money box access door 33 is released by the guillotine 92, clearly visible in FIG. 12, which is itself driven by the motor 93 through the gear wheel 97 engaged with a rack 102. The guillotine is locked in the closed position by a second lock mechanism consisting of a low power linear actuator 94, the whole being arranged inside the strongbox 19 called “treasure.” The actuator and the motor are controlled by an electronic circuit 95 disposed inside the strongbox 19 and driven by encrypted signals. The activation of the actuator 94 causes the locking pin 96 to be pulled out of the aperture 101 and the guillotine to be released. This assembly is arranged on a base that can be removed from the money-operated machine through the opening of the cylinder 112 that in turn actuates the lever 115 through the bolt 98. Thus, this mechanism enables manual intervention by means of a key 113 in case of failures. The lock illustrated in FIG. 13 is housed horizontally in a compartment 114 so as to impede attacks by means of a vertical drilling tool or the like. Access to the device takes place from the printer and paper compartment 35 located above the lock.

1. Money-operated machine comprising a housing made from an extruded profile and having a compartment housing a money acceptor and a compartment housing a money box in communication with the money acceptor, wherein, in order to protect the money collected, the money box is housed in a strongbox comprising metal sheets fitted into each other by indentations cut on an edge of the metal sheets and assembled to the extruded profile in such a way that the indentations are inserted into grooves or notches of the extruded profile acting as slides.

2. Money-operated machine according to claim 1, wherein the indentations are crenellations.

3. Money-operated machine according to claim 2, wherein some of the indentations that fit into each other are bounded and thus take the form of openings.

4. Money-operated machine according to claim 1, wherein the indentations are partially split at their base to have a slot parallel to the edge of the metal sheets.

5. Money-operated machine according to claim 1, wherein some bars cross through the metal sheets and the extruded profile to integrally secure the extruded profile and the strongbox to fixing rods.

6. Money-operated machine according to claim 1 wherein an access door of the strongbox is designed to integrally secure the extruded profile to the strongbox.

7. Money-operated machine according to claim 1, wherein a gap left between the metal sheets of the strongbox fitted into each other and the extruded profile is filled with materials that melt under friction to impede the extruded profile to be cut by means of a grinding tool.

8. Money-operated machine according to claim 1, wherein inside the strongbox, a guillotine actuated by a motor through a gear wheel and locked in the closed position by a lock mechanism comprises a low power linear actuator, and an electronic circuit controls said motor and said actuator to open the money box access door.
